(19) United States
(12) Patent Application Publication
(10) Pub. No.: US 2018/0146164 A1
(43) Pub. Date: May 24, 2018

(54) VIRTUAL SAFETY NETWORK

(71) Applicant: Securonet, Minneapolis, MN (US)

(72) Inventor: Justin C. Williams, Minneapolis, MN (US)

(21) Appl. No.: 15/668,149

(22) Filed: Aug. 3, 2017

Related U.S. Application Data
(63) Continuation of application No. 14/727,138, filed on Jun. 1, 2015, now abandoned.

(51) Int. Cl. H04N 7/18; G06K 9/00

(52) U.S. Cl. CPC H04N 7/181; G06K 9/00771

(57) ABSTRACT

A virtual safety network that allows law enforcement access to a plurality of privately owned recording devices through an interactive map.

### RELATED APPLICATIONS

This application is a continuation of application Ser. No. 14/727,138, filed Jun. 1, 2015, the teachings of which are incorporated herein by reference.

### FIELD OF THE INVENTION

The invention generally relates to a surveillance asset aggregation platform, and, more particularly, to the creation of a virtual safety network using the aggregated asset platform.

### BACKGROUND OF THE INVENTION

Urban law enforcement face unprecedented challenges in recent times. In particular, the use of surveillance cameras have become very important in gathering critical information concerning an event such as a crime. For example, in the Boston Marathon bombing of 2013, law enforcement was challenged to piece together what had transpired and who had perpetrated the crimes. Law enforcement had to first search for surveillance equipment located in the vicinity of the event that may have captured useful information, locate the owner of the surveillance equipment and then request footage from the owner of the surveillance equipment. Coordinating such an effort is extremely time consuming, cumbersome and man intensive. In addition, valuable time is lost in capturing the alleged perpetrators.

It would be desirable to provide a system that could avoid such disadvantages.

### SUMMARY OF THE INVENTION

According to an aspect of the invention, there is provided a virtual safety network for a geographic area that includes a secure web-based platform, a database operatively coupled to the platform and a plurality of privately owned and publically owned recording devices. A collaboration manager is also operatively coupled to the platform. The platform generates an interactive map illustrating the geographic locations of the privately and publically owned recording devices. An online portal allows the generation of an incident report and its distribution to the plurality of privately-owned recording devices for information that their recording devices may have recorded.

According to another aspect of the invention, there is provided a method of creating virtual safety network for a geographic area.

According to still another aspect of the invention there is a non-transitory computer-readable medium for storing a computer program which, when executed by a processor, causes the processor to perform a method for creating a virtual safety network.

### BRIEF DESCRIPTION OF THE DRAWINGS

The following description of the embodiments of the invention can be understood in light of the Figures, which illustrate specific aspects of the embodiments of the invention and are a part of the specification. Together with the following description, the Figures demonstrate and explain the principles of the invention. The figures presented in conjunction with the description are views of only particular, rather than complete, portions of the systems and methods of making and using the system according to the embodiments of the invention.

FIG. 1 illustrates a virtual safety network 10 for a geographic area according to an embodiment of the invention.

FIG. 2 illustrates a screenshot of a camera owner's location page.

FIG. 3 is a screenshot of a camera owner's camera location.

FIG. 4 is a screenshot a law enforcement official would see displaying a geographic area.

FIG. 5 illustrates a screen shot of an incident request being created.

FIG. 6 is a screen shot of a corresponding email that will be sent to camera owners based on the incident request.

FIG. 7 is a screenshot of a map showing outstanding incident requests based on the location of the requests.

FIG. 8 is a screenshot that a collaborations manager sees of a particular location in which one camera is displayed on the map.

FIG. 9 is a screenshot of current incident requests displayed on a map.

FIG. 10 shows a videolink screenshot that the manager can access along with a list of videolinked cameras.

FIG. 11 shows a sharelink screenshot that the manager can see on a map.

### DETAILED DESCRIPTION OF THE DRAWINGS

The embodiments of the invention provide a web-based platform that aggregates surveillance equipment such as cameras and video recorders from both the private and public sectors to dramatically enhance law enforcement surveillance capabilities. The technology is a highly cost effective force multiplier that provides for sharing surveillance content by and between private sector and law enforcement. The technology serves as deterrence to crime and a major enhancement to law enforcement for both proactive and reactive investigations. Through the platform, law enforcement can seek historical recorded surveillance data as well as conduct real time surveillance.

The platform allows both private and public sectors to register their external surveillance cameras onto the platform. The registration may be free or in may be made available on a subscription basis. The platform generates an interactive map on which the surveillance assets are geographically located. Members of the platform can communicate among themselves to share intelligence and alerts. Through the platform, law enforcement can swiftly access real time and/or historical surveillance data thus dramatically enhancing investigative capabilities.

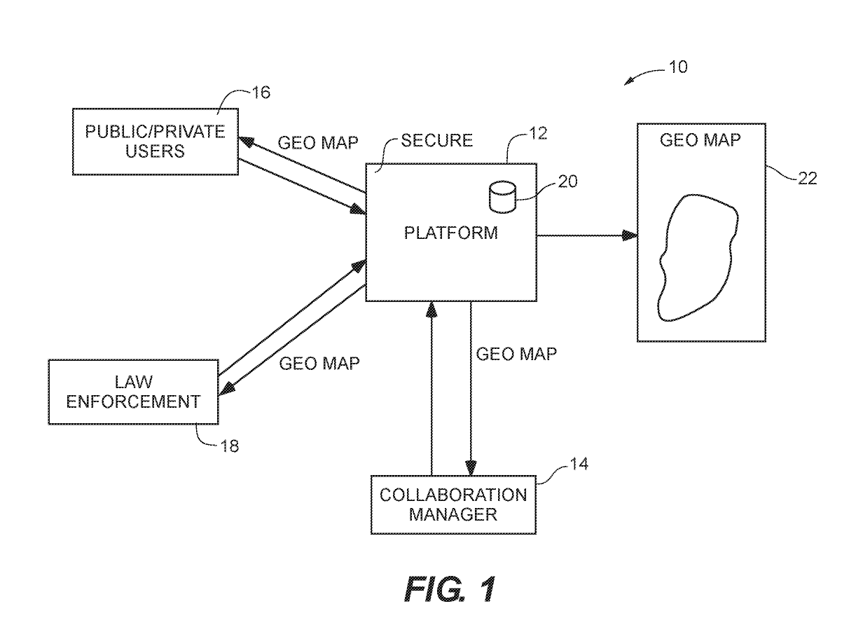

FIG. 1 illustrates a virtual safety network 10 for a geographic area according to an embodiment of the invention. The network 10 includes a web-based secure platform 12. The platform 12 communicates with a database 20 which may be located on the platform or remotely located therefrom. Various users can access the platform using computers and mobile devices, for example. The users include a collaboration manager 14, owners of publicly owned and privately owned surveillance devices 16 and law enforcement 18. The database 20 stores information that is used by the platform to communicate with the users which will be described in detail hereinafter. An interactive map 22 is generated by the platform using information stored in the database 20 among other information. Processors are operatively coupled to the platform to execute programs that allow the various communications between the users and the platform. Overall the platform enables public and private entities to join forces on a virtual safety network to investigate and potentially reduce or prevent crime. Members of the platform can easily collaborate and share information with one another. A network of security equipment such as cameras and video recorders are made available to monitor, prevent and prosecute crime thereby creating safer neighborhoods and environments. A suite of collaboration tools allow businesses and neighborhoods to join forces to share data and pictures and/or video, thereby aiding in the investigation and prevention of crime. The platform has 3 main components which will now be described in detail.

The first component is a safelink topology. In the safelink topology, a plurality of publically owned and privately owned cameras sign up to be a part of the network. A secure on-line portal can be used to provide secure registration. Unique profiles are created for the various users' camera owners, law enforcement and collaboration manager. Each registered member has its unique member profile. The platform outputs an interactive map of a geographic location and the location of each of the surveillance devices to the platform are appropriately displayed in their respective locations on the map. By looking at the interactive map, one can see where the cameras are positioned and determine what cameras may have possibly captured picture or footage that might prove useful to investigate a crime at a location. Law enforcement can generate an incident request asking camera owners for specific information or asking to share camera captured information. Unlike the situation described with reference to the Boston Marathon bombing, the platform generates an easy to use system so that law enforcement can see what cameras are available in a specific area and generate requests for information on-line instead of the cumbersome and labor intensive practice that currently exists.

The second component is a videolink topology. In this topology, real-time video surveillance capabilities are available. For example, law enforcement can request camera owners to record footage during a specific time, for example, during a planned demonstration or parade. If an event unfold during that event, law enforcement will have real-time footage to aid in investigating an issue or respond to an unfolding event. Permission based video sharing is when a camera owner wants to share live video feeds to members. This is accomplished by a setup permission table that allows the camera owner to select which members can view their live feed.

The third component is a sharelink topology that provides a set of easy-to-use collaboration tools for members to create a virtual community. The members have access to a membership directory to enable collaboration within the community. Instant messaging is available to allow members to quickly connect with other members and law enforcement. Community forums are available to facilitate information sharing. Also, community alerts and emergency bulletins can be broadcast to the community using the collaboration tools. The tools helps create a virtual community that is committed to creating a safe and secure environment for the community.

The second and third components may be supplied as part of the base platform or they may be made available on an upgrade basis.

Referring back to FIG. 1, there are various users of the platform. The users include camera owners, both publically owned and privately owned, law enforcement and a collaboration manager. Law enforcement can generate incident requests as well as request for real-time footage. Law enforcement can also publish and communicate with members of the platform regarding important information such as bulletins and alerts, for example. The collaboration manager oversees and manages the platform. The collaboration manager can invite members to register and vet potential members. The collaboration manager can measure and publish network metrics and act as a liaison between the public and private sectors. The users use their own computers or mobile devices to operatively couple with the platform through well-known means.

The camera owners can be located at businesses, government facilities and outdoor geographic locations such as street corners, stop lights, stop signs, etc. If a camera owner wants to belong to the platform, the camera owner needs to register its camera with the platform. This can be done through an online portal, for example. The same is true for law enforcement. The camera owner includes contact information and information about the camera and its location through its registration.

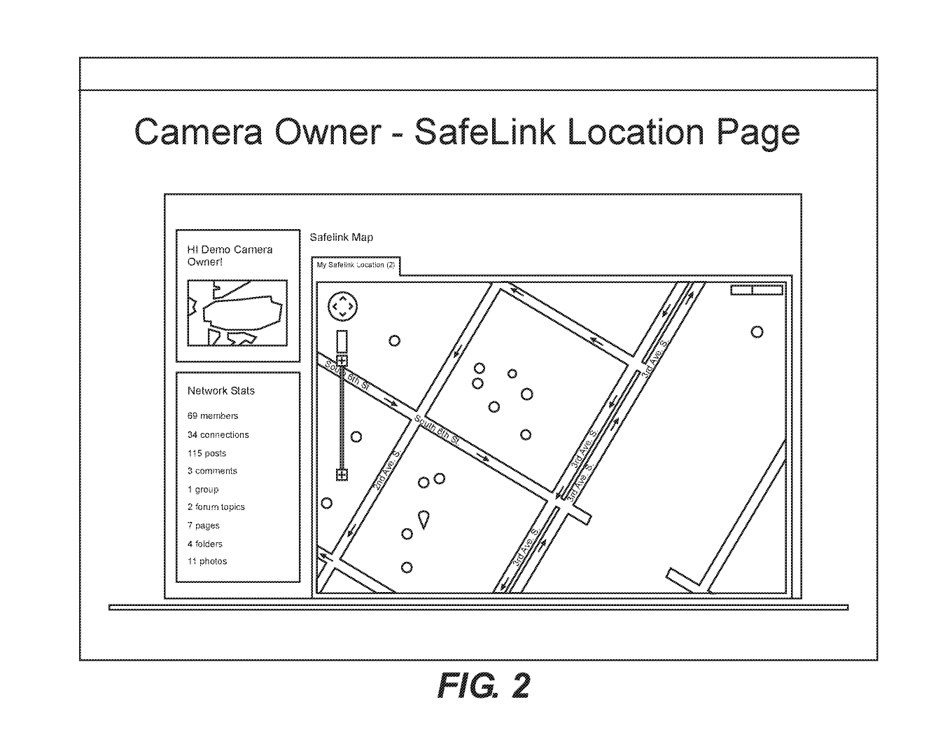

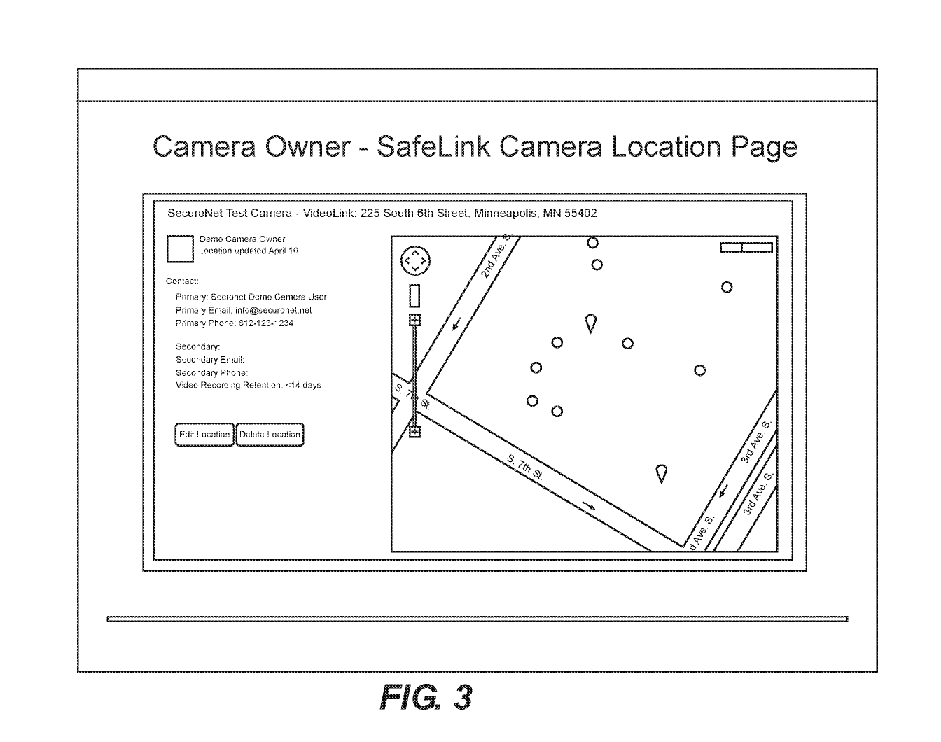

FIG. 2 illustrates a screenshot of a camera owner's location page. A map is also displayed to show the camera owner's cameras locations in the vicinity. In this example, this camera owner has two cameras 22. If the camera owner selects a particular camera, the screenshot of FIG. 3 is shown. From this screen, the owner can edit information concerning its contact information and its retention policy or delete the camera from its location and from the platform. The registered camera owners maintain its profile information and video and picture assets. The camera owners also keep a list of real-time video permissions which will be discussed hereinafter. The camera owner is responsible for responding to incident requests and thereby sharing its camera contents with law enforcement as will be described. The camera owner can only see its cameras on the displayed interactive map. Law enforcement and the collaboration manager can see all of the registered cameras.

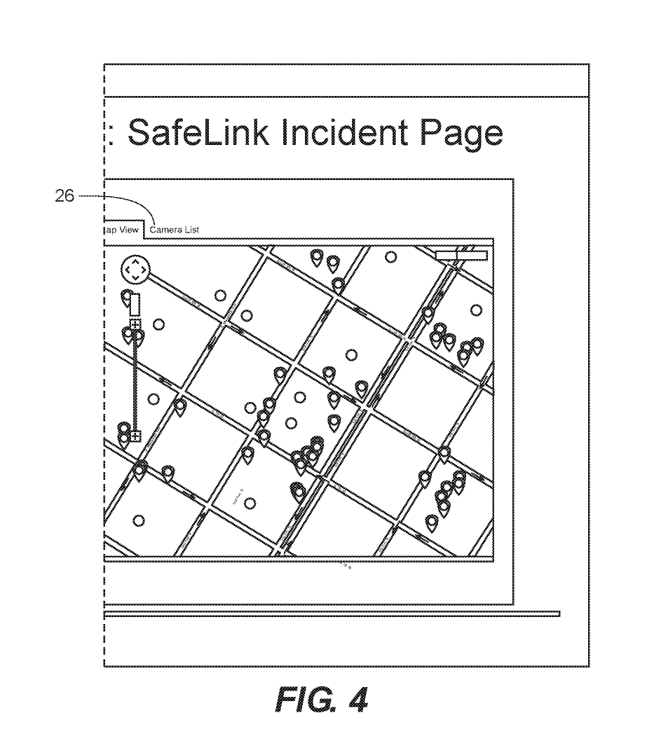

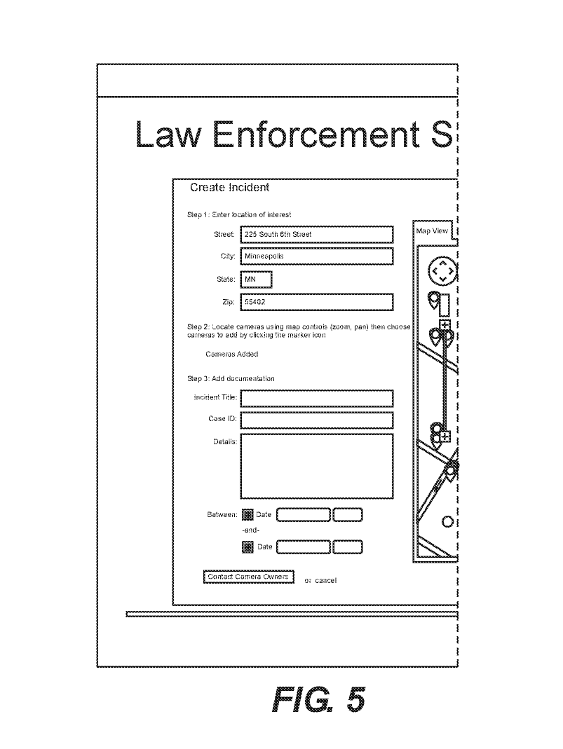

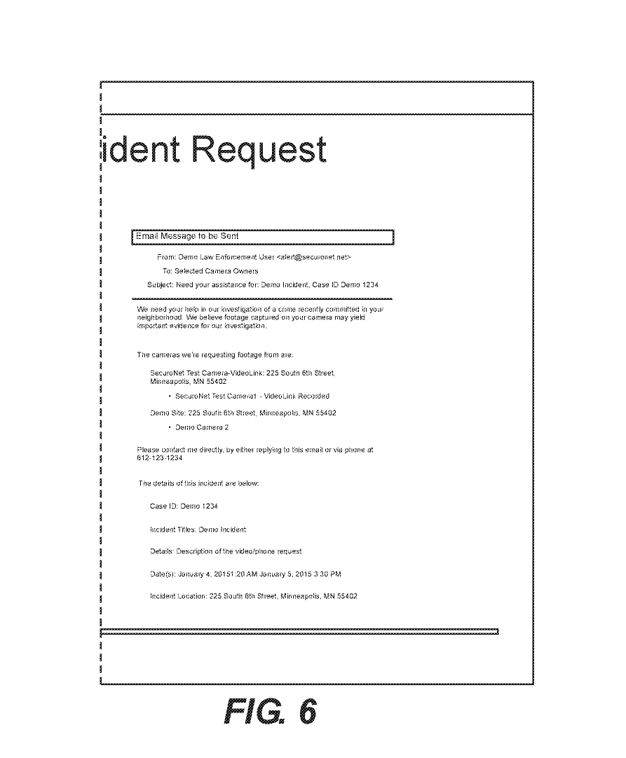

FIG. 4 is a screenshot a law enforcement official would see displaying a geographic area. The cameras 32 that are located in this area are illustrated on the map and the officer can hover over any one of them and get information about a particular camera displayed in a popup box. Alternatively, the officer can click on a particular camera and retrieve contact information about that camera. As can be seen in the screenshot, the officer also has the ability to open a tab 26 listing all of the cameras from which a particular one can be selected. Law enforcement can create an incident request to be sent to camera owners. FIG. 5 illustrates a screen shot of an incident request being created. FIG. 6 is a screen shot of a corresponding email that will be sent to camera owners based on the incident request. To create an incident request, law enforcement enters the location of the incident. Then the officer locates cameras that may have captured relevant footage based ion their location and selects the cameras of interest. The officer then enters an incident title, case ID, details and date and time range. The email shown in FIG. 6 is created and the officer can select to contact the selected camera owners and the email will be sent to those camera owners. When the camera owner receives an incident request from law enforcement, they collect footage from their camera pertaining to the designated day and time range requested and can email the footage to law enforcement.

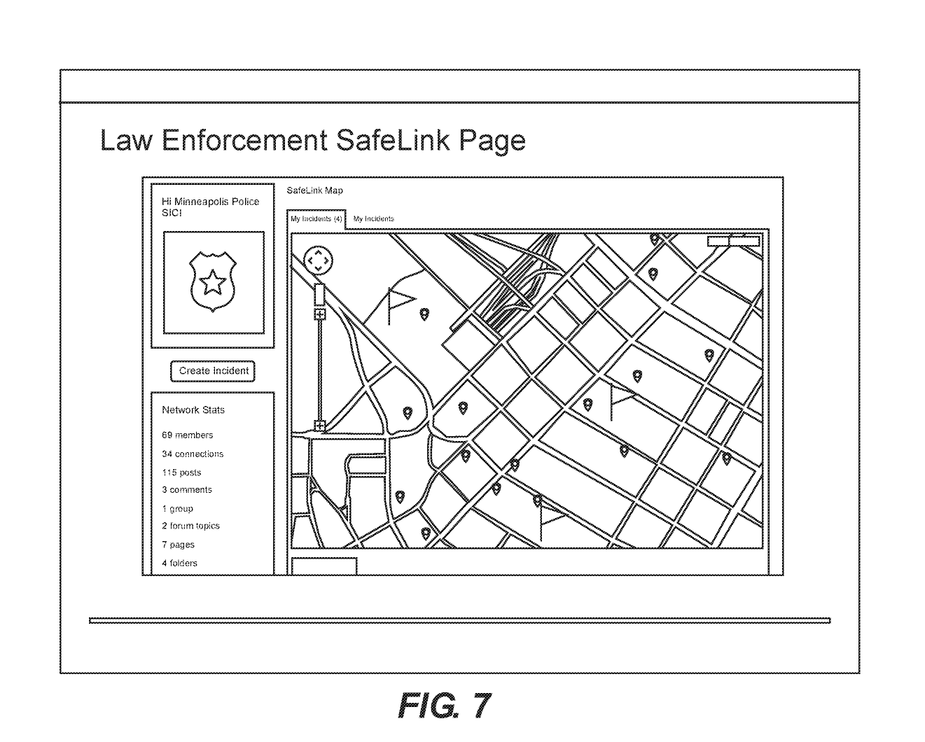

FIG. 7 is a screenshot of a map showing outstanding incident requests based on the location of the requests. In this example, there are 4 incident requests designated by flags 34.

A recent case study will highlight the benefits and efficiencies the platform offers to the community and law enforcement. Recently, on Mar. 17, 2015 in downtown Minneapolis, following a St. Patrick's parade, hundreds of teens got into several large fights. The Minneapolis police sent out an incident request to 11 members on the platform for video footage. A total of 34 cameras sent video footage, 2 arrests were made and other suspects were captured thanks in large part to the ability to issue an incident request. Police were able to leverage $170,000 worth of camera assets using the platform.

In the same incident, an incident request was sent to 10 companies owning a total of 27 cameras about a shooting. An arrest was made and law enforcement leveraged about $135,000 worth of camera assets to investigate the incident.

In summary, law enforcement had 21 members who owned 61 cameras located in the area of interest retrieving relevant footage. Law enforcement leveraged about $305,000 worth of video assets during their investigation. Critical video footage that helped the investigation came from members of the platform.

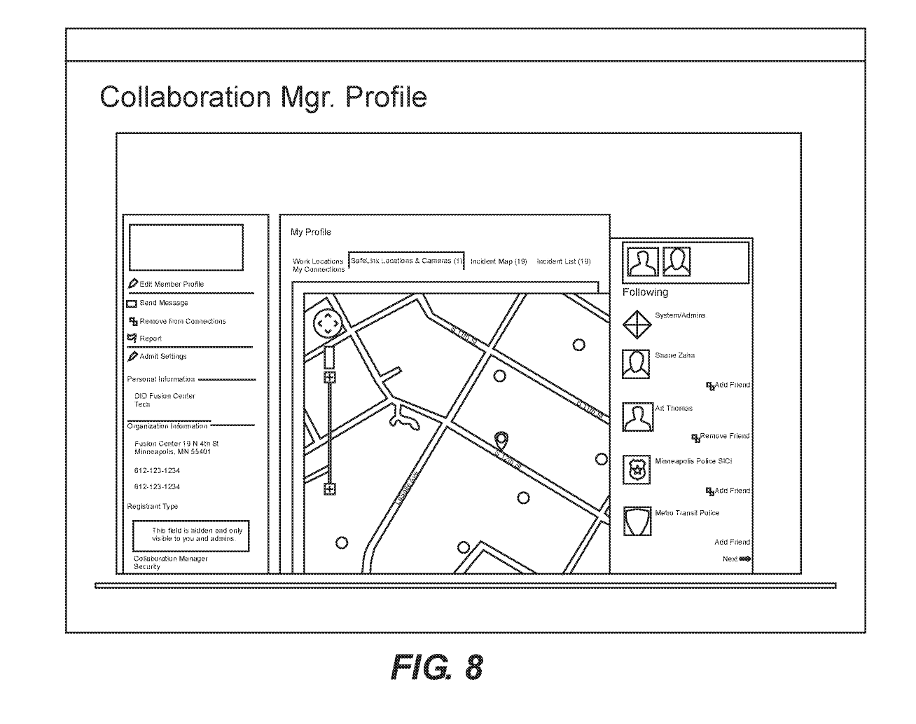

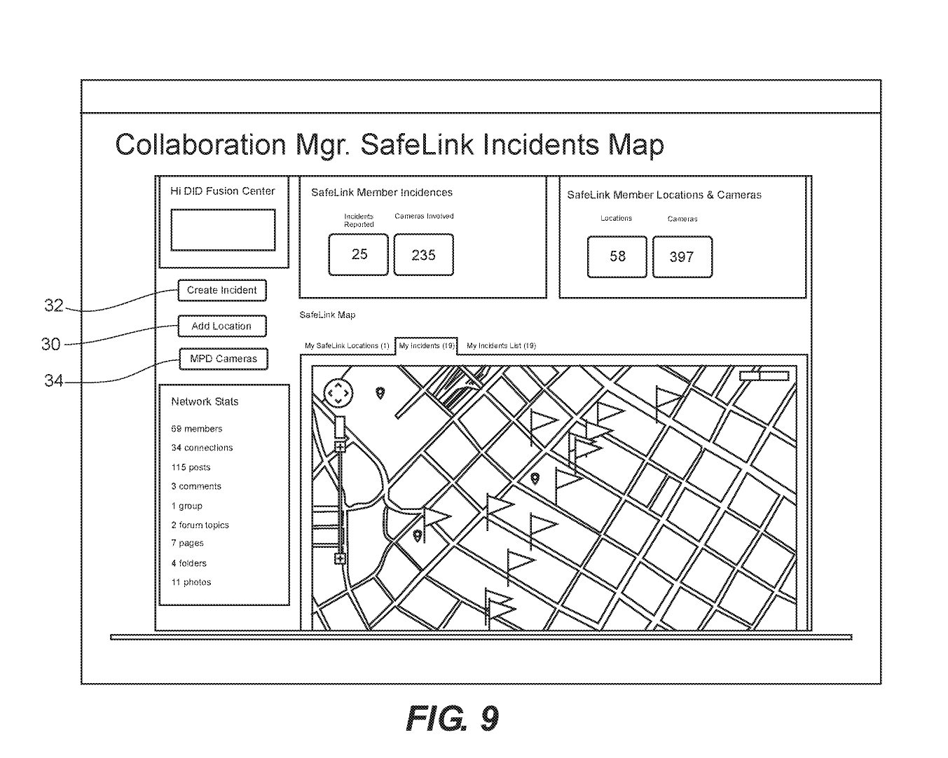

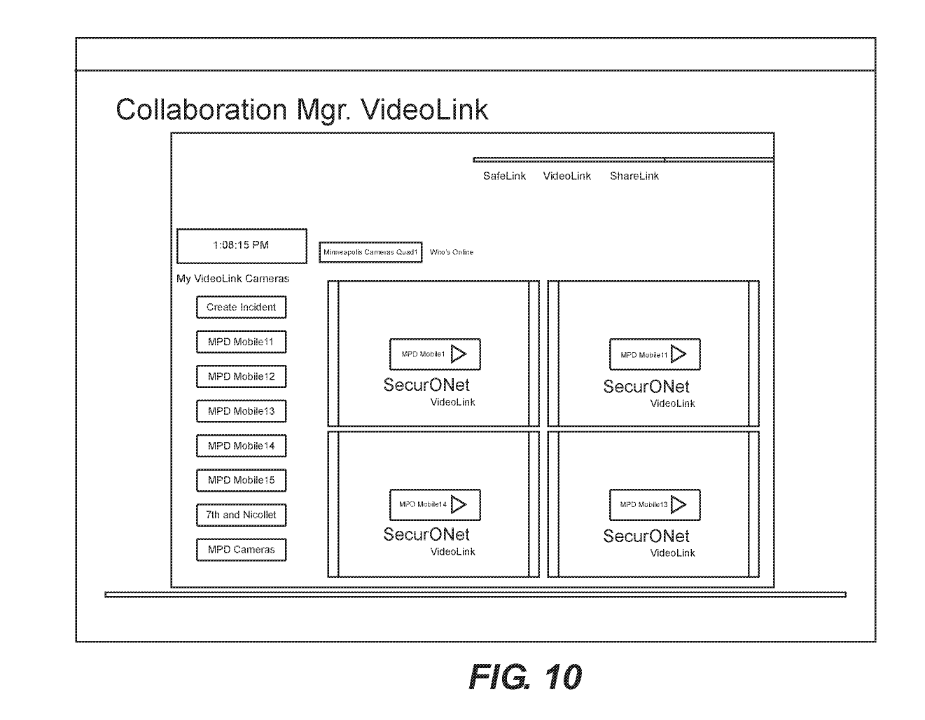

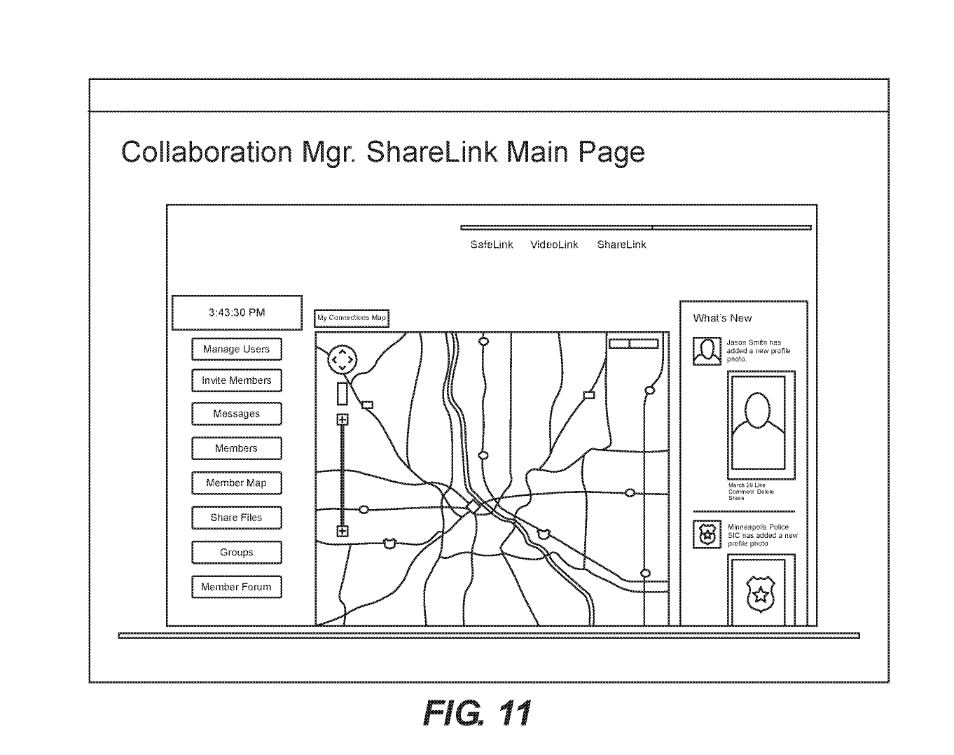

FIG. 8 is a screenshot that a collaborations manager sees of a particular location in which one camera is displayed on the map. From this screen the manager can edit a member's profile, send a message as well as other activities as shown. FIG. 9 is a screenshot of current incident requests displayed on a map. The manager can add camera locations 30, create incident requests 32 as well as display video cameras. The manager also sees the number of incident reported as well as the number of cameras involved by viewing its dashboard as well as showing the member locations and number of cameras. The information shown on all of the screenshots gets periodically refreshed. FIG. 10 shows a videolink screenshot that the manager can access along with a list of videolinked cameras. FIG. 11 shows a sharelink screenshot that the manager can see on a map. The safelink page for the camera owner and law enforcement are the same except sensitive information is only displayed to the manager. The collaboration manager will have access to administrative pages for tasks like resetting passwords, and removing accounts. They can also invite members and assign a membership type to members.

There are many benefits to both the private sector and law enforcement. The private sector benefits because the integration of private security cameras on the platform serves as a deterrent to crime in and around their place of business and provides a mechanism to share intelligence alerts and warnings. Law enforcement benefits because the platform provides a relatively inexpensive and extremely efficient tool to identify and obtain both historical camera data and real-time security camera data. Therefore, evidence for reactive and historical investigations can be swiftly and efficiently obtained. Furthermore, proactive investigations are also enhanced. For example, for public celebrations or major events, law enforcement can use the platform to proactively direct both public and private surveillance assets on the event thus creating a force multiplier. Also, it is financially appealing to law enforcement as they do not have to purchase more surveillance assets but can use those already existing.

The present disclosure is not to be seen as limited by the embodiments described above, but can be varied within the scope of the claims, as will be readily understood by the person skilled in the art.

What is claimed:

1. A virtual safety network for a geographic area comprising:
a secure web-based platform for hosting the virtual safety network;
a database operatively coupled to the secure platform for storing information;
a collaboration manager operatively coupled to the secure platform to manage the platform;
a plurality of privately owned recording devices operatively coupled to the secure platform;
a plurality of publically owned recording devices operatively coupled to the secure platform,
wherein the secure web-based platform generates an interactive map illustrating the geographic locations of the privately owned and publically owned recording devices on the interactive map; and
an online portal for generating an incident report and distributing the incident report to the plurality of privately-owned recording devices for information that their recording devices may have recorded.

2. The network of claim 1 wherein the recording devices are selected from among cameras and video cameras.

3. The network of claim 1 wherein information about the privately owned and publically owned recording devices is stored in the database and includes information about geographic location and ownership.

4. The network according to claim 3 wherein the information is displayed on the interactive map.

5. The network according to claim 1 wherein the incident report includes a location of interest and a time range.

6. The network of claim 1 further comprising an online portal for generating a request for real-time recording by at least one of the privately owned recording devices.

7. The network of claim 1 further comprising an online portal for gaining access to at least one of the privately owned recording devices on a permissions basis.

8. The network of claim 1 further comprising an online portal for registering a privately owned recording device to the secure network.

9. The network of claim 8 wherein registration is on a subscription basis.

10. The network of claim 5 wherein the incident report is emailed to the plurality of privately and publically owned recording devices.

11. A method of creating a virtual safety network for a geographic area comprising:
providing a secure web-based platform for hosting the virtual safety network including a database operatively coupled to the secure platform for storing information;
coupling a plurality of privately owned recording devices to the secure platform;
coupling a plurality of publically owned recording devices to the secure platform,
generating an interactive map illustrating the geographic locations of the privately owned and publically owned recording devices on the interactive map; and
generating an incident report and distributing the incident report to the plurality of privately-owned recording devices for information that their recording devices may have recorded.

12. A non-transitory computer-readable medium storing computer program code which,
when executed by a processor, causes the processor to perform a method for creating a virtual safety network for a geographic area comprising:
providing a secure web-based platform for hosting the virtual safety network including a database operatively coupled to the secure platform for storing information;
coupling a plurality of privately owned recording devices to the secure platform;
coupling a plurality of publically owned recording devices to the secure platform,
generating an interactive map illustrating the geographic locations of the privately owned and publically owned recording devices on the interactive map; and
generating an incident report and distributing the incident report to the plurality of privately-owned recording devices for information that their recording devices may have recorded.
